(19) United States
(12) Patent Application Publication
(10) Pub. No.: US 2007/0041754 A1
(43) Pub. Date: Feb. 22, 2007

(54) Belt unit and image forming apparatus

(75) Inventors: Takaaki Hachisuga, Kanagawa-ken (JP); Satoshi Kaiho, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/206,176

(22) Filed: Aug. 18, 2005

(51) Int. Cl. G03G 15/01

(52) U.S. Cl. 399/302

(57) ABSTRACT

The present invention provides support rollers on both sides of a first tension roller having a small roller diameter and an acute winding angle of an intermediate transfer belt. Ribs installed at both ends of an inner peripheral surface of the intermediate transfer belt are supported by the support rollers to prevent the intermediate transfer belt from bending when a slit formed in a joint of the ribs passes the first tension roller. By doing this, variations in the belt conveying speed of the intermediate transfer belt are reduced and on the intermediate transfer belt of a belt unit aiming at miniaturization, a highly precise transfer image free of image disturbance is obtained.

### FIELD OF THE INVENTION

The present invention relates to a belt unit for forming a toner image on a recording medium using an endless transfer belt and an image forming apparatus.

### DESCRIPTION OF THE BACKGROUND

In recent years, there is an electro-photographic image forming apparatus such as a copier or a printer for primarily transferring a toner image on a photoconductor to an endless intermediate transfer belt and then secondarily transferring it to a recording medium. The intermediate transfer belt, to prevent an occurrence of a horizontal shift while being stretched, suspended, and driven to rotate by a plurality of rollers, conventionally as shown in FIG. 1, is affixed with ribs 2 made of rubber at both ends of intermediate transfer belt 1. In conventional intermediate transfer belt 1, when the horizontal shift is increased, ribs 2 touch the side of roller 3, thus the horizontal shift is prevented from extending.

However, ribs 2 are different in material from intermediate transfer belt 1 and are affixed to both ends of intermediate transfer belt 1 after forming. Therefore, since intermediate transfer belt 1 and ribs 2 are different in thermal expansion coefficient, to prevent ribs 2 from overlapping at the joint when in use, a slit with a width of about 4 mm is provided at the joint of rib 2.

However, conventionally, when the slit at the joint of rib 2 passes roller 3, the behavior of intermediate transfer belt 1 may be changed. Generally, the belt conveying speed of intermediate transfer belt 1 is not uniform and is slightly changed due to the horizontal shift. However, at the joint of rib 2, the surface of intermediate transfer belt 1 is bent and extended by the slit, so that the belt conveying speed is changed larger. Moreover, the changing of the behavior of intermediate transfer belt 1 caused by the slit of the joint of ribs 2, when the diameter of roller 3 is small and the winding angle of intermediate transfer belt 1 with roller 3 is reduced, becomes conspicuous.

Therefore, conventionally, if the diameter of roller 3 for stretching and suspending intermediate transfer belt 1 is reduced to miniaturize the apparatus and the winding angle of intermediate transfer belt 1 with roller 3 is made acute, when the joint of ribs 2 passes roller 3, the belt conveying speed is changed greatly and a toner image may be disturbed. Furthermore, when superimposing toner images of a plurality of colors on intermediate transfer belt 1 to obtain a color image, the belt conveying speed is changed greatly, thus the color superimposition precision is impaired, and the image quality may be lowered.

Therefore, even when the diameter of the roller for stretching and suspending the intermediate transfer belt equipped with the ribs for preventing the horizontal shift is reduced, a belt unit for preventing changing in the behavior of the intermediate transfer belt caused by the slit of the joint of the ribs and obtaining a highly precise image free of disturbance of a toner image and an image forming apparatus are desired.

### SUMMARY OF THE INVENTION

Therefore, the present invention is intended in the belt unit for realizing miniaturization to prevent a toner image transferred onto the intermediate transfer belt from disturbance and improve the image quality.

To accomplish the above effect, according to the embodiment of the present invention, there is provided a belt unit comprising: an endless belt base material driven rotatably to carry a toner image; rib members projected on both sides of an inner periphery of the endless belt base material in parallel with the rotation driving direction; a roller member in contact with the inner peripheral surface of the endless belt base material to drive rotatably the endless belt base material; and support members in contact with the rib members at positions opposite to the rib members on both sides of the roller member to support the rib members.

### BRIEF DESCRIPTION OF THE DRAWINGS

FIG. 1 is a schematic illustration showing a conventional roller for stretching and suspending an intermediate transfer belt;

FIG. 2 is a schematic block diagram showing the image forming unit of the color copier of the embodiment of the present invention;

FIG. 3 is a schematic block diagram showing the intermediate transfer belt of the embodiment of the present invention;

FIG. 4 is a schematic illustration showing the first tension roller and support roller for stretching and suspending the intermediate transfer belt of the embodiment of the present invention;

FIG. 5 is a graph showing variation in the belt conveying speed of the intermediate transfer belt of the embodiment of the present invention; and

FIG. 6 is a drawing (Table 1) showing the image quality of transfer images when the diameter of the first tension roller is changed in a conventional belt unit and the belt unit of the embodiment of the present invention.

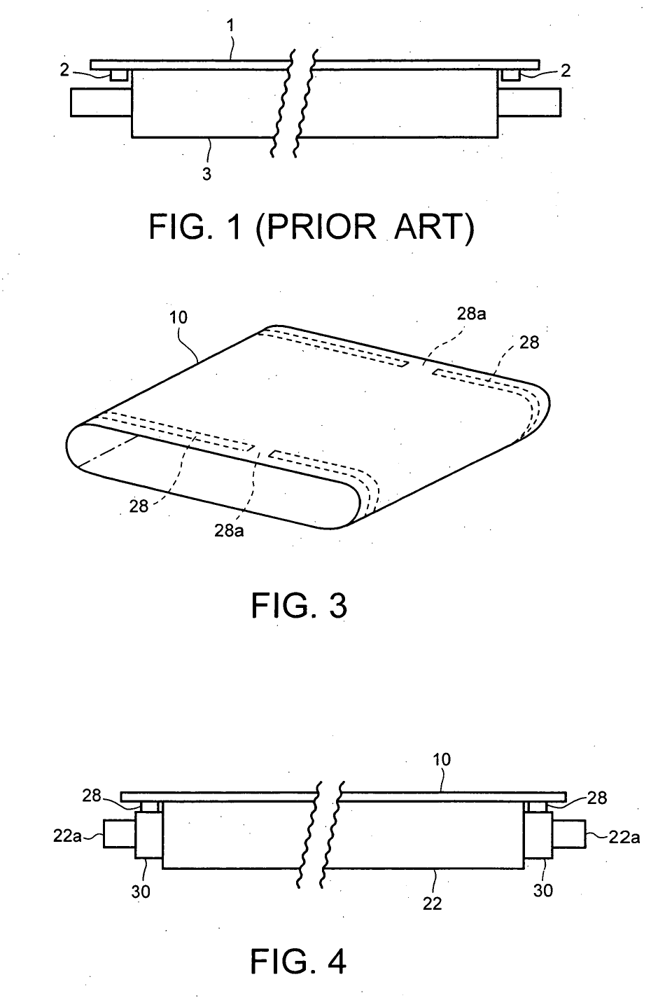

### DETAILED DESCRIPTION OF THE EMBODIMENTS

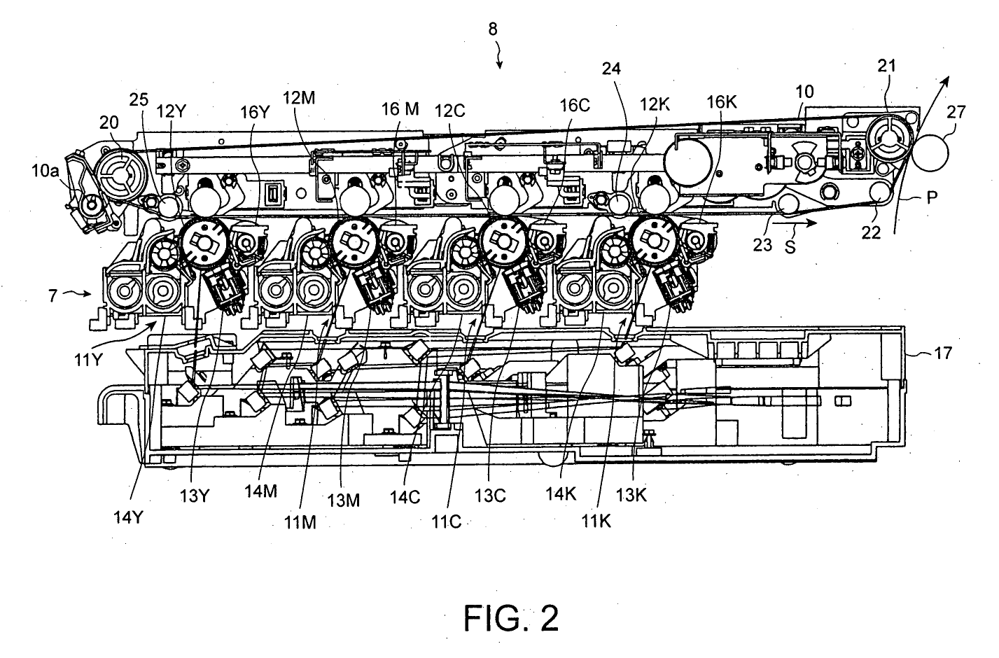

Hereinafter, the embodiment of the present invention will be explained in detail with reference to the accompanying drawings. FIG. 2 is a schematic block diagram showing image forming unit 7 of a color copier of a 4-each tandem type which is an image forming apparatus of the embodiment of the present invention. Image forming unit 7 has four image forming units 11Y, 11M, 11C and 11K of yellow (Y), magenta (M), cyan (C) and black (K) arranged in parallel along the lower side of intermediate transfer belt 10 which is an endless belt composing a belt unit 8.

Image forming units 11Y, 11M, 11C and 11K respectively have photosensitive drums 12Y, 12M, 12C and 12K which are image carrying members.

In image forming units 11Y, 11M, 11C and 11K, around photosensitive drums 12Y, 12M, 12C and 12K, in the rotational direction of the direction of arrow m, chargers 13Y, 13M, 13C and 13K, developing devices 14Y, 14M, 14C and 14K and photoconductor cleaners 16Y, 16M, 16C and 16K are arranged. Between chargers 13Y, 13M, 13C and 13K and developing devices 14Y, 14M, 14C and 14K around photosensitive drums 12Y, 12M, 12C and 12K, exposure light is irradiated from laser exposure device 17. Chargers 13Y, 13M, 13C and 13K, laser exposure device 17, developing devices 14Y, 14M, 14C and 14K and photoconductor cleaners 16Y, 16M, 16C and 16K around photosensitive drums 12Y, 12M, 12C and 12K compose a toner image forming member.

To the primary transfer position where intermediate transfer belt 10 of belt unit 8 is opposite to photosensitive drums 12Y, 12M, 12C and 12K, a primary transfer voltage is applied by primary transfer rollers 18Y, 18M, 18C and 18K and toner images on photosensitive drums 12Y, 12M, 12C and 12K are primarily transferred to intermediate transfer belt 10. Intermediate transfer belt 10 is stretched and suspended by drive roller 20, opposite roller 21 and first to fourth tension rollers 22 to 25 which are roller members composing belt unit 8. The diameter of first to fourth tension rollers 22 to 25 is about 12 mm and the winding angle of intermediate transfer belt 10 with first tension roller 22 is 57.3°.

At the secondary transfer position of intermediate transfer belt 10 supported by opposite roller 21, secondary transfer roller 27 is arranged opposite to it. To the secondary transfer position, a secondary transfer voltage is applied by secondary transfer roller 27 via sheet of paper P which is a recording medium and a toner image on intermediate transfer belt 10 is secondarily transferred to sheet of paper P. Primary transfer rollers 18Y, 18M, 18C and 18K and secondary transfer roller 27 compose a transfer member together with intermediate transfer belt 10. On the downstream side of secondary transfer roller 23 of intermediate transfer belt 10, belt cleaner 10a is installed.

Next, belt unit 8 will be described in detail. On both sides of the inner periphery of seamless intermediate transfer belt 10 made of polyimide with a thickness of about 0.1 mm, as shown in FIG. 3, fine-line rib 28 which is a rib member made of rubber with a thickness of about 1 mm is affixed respectively. Each rib 28 has slit 28a with a width of about 4 mm at the joint. Slit 28a of the joint is installed to prevent rib 28 from overlapping at the joint position due to a difference in coefficient of expansion between intermediate transfer belt 10 and rib 28. The width of slit 28a, so long as both ends of rib 28 at the joint are not overlapped, is not restricted and may be 2 mm or so.

In belt unit 8, in first tension roller 22 at a small winding angle of intermediate transfer belt 10, in the positions opposite to ribs 28 on both sides thereof, support rollers 30 which are support members shown in FIG. 4 are installed. Support rollers 30 are attached to roller shaft 22a of first tension roller 22 coaxially with and freely from first tension roller 22. First tension roller 22 stretches and suspends intermediate transfer belt 10, while support rollers 30 support ribs 28 on both sides of intermediate transfer belt 10.

Support rollers 30 are formed so that the following formula is held:
Diameter of support rollers 30=(diameter of first tension roller 22)−(thickness of ribs 28×2)
and in this embodiment, diameter of support rollers 30=12−2=10 mm. Both ends of the joint of ribs 28 are supported by support rollers 30, thus the effect of slit 28a of the joint of ribs 28 on transfer belt 10 is reduced. Further, support rollers 30 are free from roller shaft 22a, so that during supporting ribs 28, no load is caused to ribs 28 due to friction. Therefore, intermediate belt 10 is not likely to be affected by variation in the belt conveying speed due to passing of slit 28a of the joint of ribs 28 through the position of first tension roller 22.

Next, the operation of the invention will be described. When the image forming process is started and then image information is input from a scanner or a personal computer terminal, photosensitive drums 12Y, 12M, 12C and 12K are rotated and the image forming step is sequentially executed by image forming units 11Y, 11M, 11C and 11K. In image forming unit 11Y of yellow (Y), the surface of photosensitive drum 12Y is uniformly charged by charger 13Y and then a laser beam corresponding to the image information of yellow (Y) is irradiated at exposure position 17Y, thus an electrostatic latent image is formed. Furthermore, photosensitive drum 12Y forms a toner image by developing device 18Y, makes contact with intermediate transfer belt 10 rotating in the direction of arrow s, and primarily transfers the toner image onto intermediate transfer belt 10 by primary transfer roller 18Y.

At this time, at the position of first tension roller 22, the roller diameter is small such as 12 mm and the winding angle of intermediate transfer belt 10 with first tension roller 22 is acute such as 57.3°. However, support rollers 30 on both sides of first tension roller 22 support ribs 28 and support both ends of the joint at slit 28a of the joint of ribs 28.

Therefore, although slit 28a is formed in the joint of ribs 28, when slit 28a passes first tension roller 22 having a small roller diameter, intermediate transfer belt 10 will not be bent. As a result, the belt conveying speed of transfer belt 10 can be prevented from slowing down more and the variation in the belt conveying speed of transfer belt 10 caused by slit 28a of the joint of ribs 28 is reduced. Namely, the variation in the belt conveying speed of intermediate transfer belt 10 when slit 28a of the joint of ribs 28 passes first tension roller 22 is small and the yellow (Y) toner image on photosensitive drum 12Y is transferred highly precisely to intermediate transfer belt 10.

Similarly to the yellow (Y) toner image forming process, the toner image forming process of magenta (M), cyan (C) and black (K) is performed. Toner images formed on photosensitive drums 12M, 12C and 12K are sequentially superimposed and transferred to the position on intermediate transfer belt 10 where the yellow (Y) toner image is formed and a full-color toner image is formed on intermediate transfer belt 10. At this time, similarly to transfer of the yellow (Y) toner image, when slit 28a of the joint of ribs 28 passes first tension roller 22, support rollers 30 support both ends of the joint of ribs 28. Therefore, the toner images formed on photosensitive drums 12M, 12C and 12K are superimposed and transferred highly precisely free of disturbance of the images due to variation in the speed of intermediate transfer belt 10.

Hereafter, the full-color toner image superimposed on intermediate transfer belt 10 reaches the position of secondary transfer roller 27 and is secondarily transferred onto sheet of paper P in a batch by a transfer bias of secondary transfer roller 27, and then sheet of paper P is sent to the fixing step, and the toner image is completed. Intermediate transfer belt 10, after end of the secondary transfer, is cleaned residual toner by belt cleaner 10a. Further, photosensitive drums 12Y, 12M, 12C and 12K, after primary transfer of the toner images onto intermediate transfer belt 10, are removed residual toner by cleaners 16Y, 16M, 16C and 16K and are ready for the next image forming process.

Next, in belt unit 8 of this embodiment, the variation measurement test of the belt conveying speed when intermediate transfer belt 10 is driven is conducted and as a comparison example, the variation in the belt conveying speed when intermediate transfer belt 10 is driven by a conventional belt unit having no support rollers 30 is measured. For variation measurement of the belt conveying speed, the conveying face of intermediate transfer belt 10 is measured using a laser Doppler speedometer.

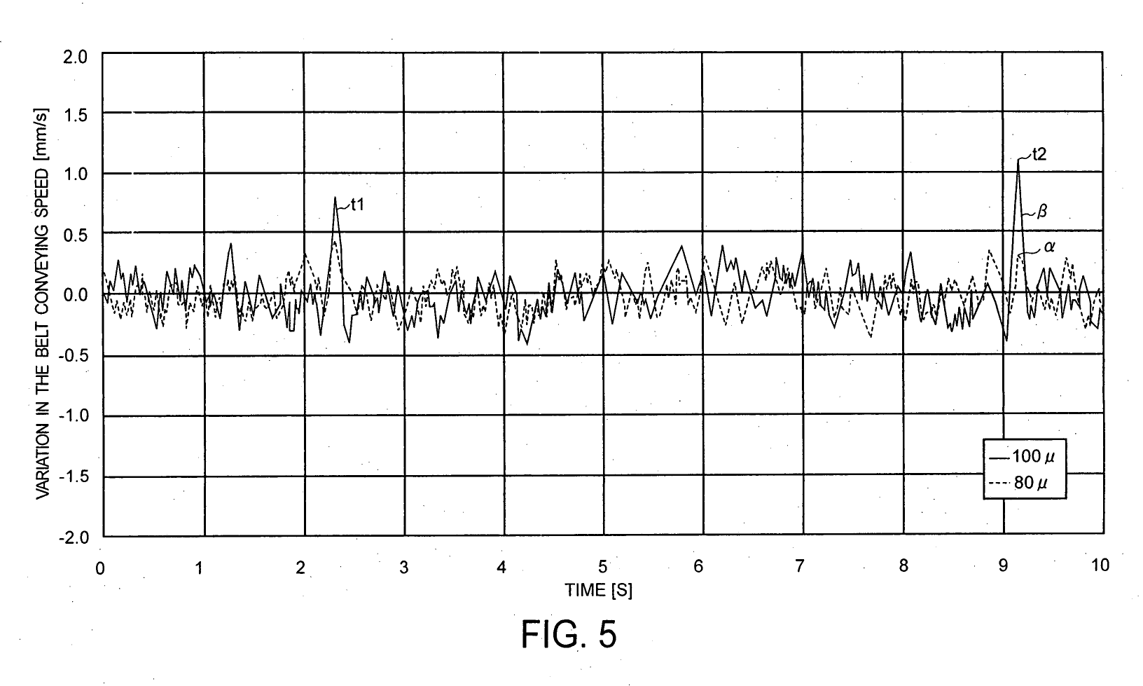

As shown in FIG. 5, in the conventional belt unit with no support rollers 30 installed, as shown by dotted lines B, at the timing (t1, t2) with passing of slit 28a of the joint of ribs 28 through first tension roller 22, the belt conveying speed of intermediate transfer belt 10 is varied greatly. On the other hand, in belt unit 8 of this embodiment, it is ascertained that as shown by solid lines ∂, the variation in the belt conveying speed of intermediate transfer belt 10 at timing t1 and t2 is reduced and a highly precise transfer image can be obtained.

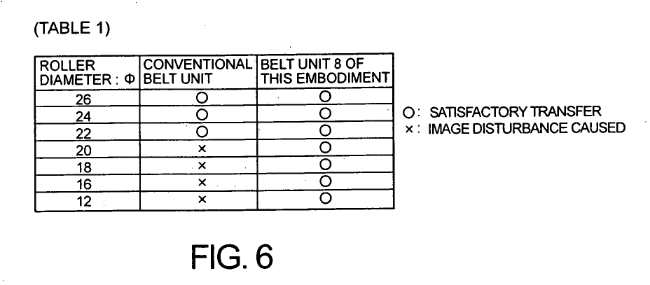

Next, in belt unit 8 of this embodiment and conventional belt unit 8, the winding angle of intermediate transfer belt 10 of first tension roller 22 is kept at 57.3°, and the diameter of first tension roller 22 is changed, and the variation measurement test of the belt conveying speed of intermediate transfer belt 10 is conducted. As a result, as shown in Table 1 in FIG. 6, in the conventional belt unit, when the roller diameter is 20 mm or smaller, the belt conveying speed of intermediate transfer belt 10 at timing t1 and t2 is varied greatly and the transfer image is disturbed. Compared with it, in belt unit 8 of this embodiment, it is ascertained that even if the roller diameter is within the range from 12 mm to 20 mm, the belt conveying speed of intermediate transfer belt 10 at timing t1 and t2 is varied little and satisfactory transfer is obtained.

According to this embodiment, on both sides of first tension roller 22 for stretching and suspending intermediate transfer belt 10, ribs 28 are supported by support rollers 30 and both ends of ribs 28 are supported by support rollers 30 even at slit 28a of the joint of ribs 28. Therefore, to miniaturize belt unit 8, even if the winding angle of intermediate transfer belt 10 is made acute and the diameter of first tension roller 22 is made smaller, when slit 28a formed in the joint of ribs 28 passes first tension roller 22, intermediate transfer belt 10 can be prevented from bending and the variation in the belt conveying speed of intermediate transfer belt 10 can be made smaller. As a result, unless the image is disturbed by speed variation of intermediate transfer belt 10, the toner images on photosensitive drums 12Y, 12M, 12C and 12K can be transferred highly precisely to intermediate transfer belt 10 and a small image forming apparatus of high image quality can be realized.

Further, the present invention is not limited to the embodiment aforementioned and can be modified variously within the scope of the present invention. For example, the number of image forming members and the kind of colors of toner images are not restricted, and using a developing device using an image forming member of a revolver type instead of a tandem type, a latent image on a single image carrying member may be developed sequentially. Further, the material and thickness of the endless belt base material are not restricted and any type other than the seamless type may be used. The material and thickness of the rib member are not restricted and the size of the slit of the joint is neither restricted.

Furthermore, the diameter of the roller member and the winding angle of the endless belt base material with the roller member are not restricted so long as a highly precise transfer image is obtained. Further, the structure of the support member is optional and the support member may be formed integrally with the roller member.

As mentioned above, according to the present invention, even if the diameter of the roller member for stretching and suspending the endless belt base material is made smaller and the winding angle of the endless belt base material is made smaller, when the rib member for preventing the endless belt base material from a horizontal shift is supported by the support member, the variation in the belt conveying speed of the endless belt base material when the joint of the rib member passes the roller member can be reduced, and the toner image at time of transfer can be prevented from disturbance. Therefore, unless the image quality is impaired, a small belt unit and moreover an image forming apparatus can be put into practical use.

What is claimed is:

1. A belt unit comprising:
an endless belt base material driven rotatably to carry a toner image;
rib members projected on both sides of an inner periphery of the endless belt base material in parallel with the rotation driving direction;
a roller member in contact with the inner peripheral surface of the endless belt base material to drive rotatably the endless belt base material; and
support members in contact with the rib members at positions opposite to the rib members on both sides of the roller member to support the rib members.

2. The belt unit according to claim 1, wherein the rib members are provided on the inner periphery of the endless belt base material so that a joint has a space.

3. The belt unit according to claim 2, wherein the endless belt base material is seamless.

4. The belt unit according to claim 1, wherein the support members are formed in a roller shape coaxial with the roller member.

5. The belt unit according to claim 4, wherein the support members rotate freely round a shaft of the roller member.

6. The belt unit according to claim 1, wherein a roller diameter of the roller member is smaller than 22 mm.

7. The belt unit according to claim 6, wherein the support members are formed in a roller shape coaxial with the roller member and the following formula is held:
Diameter of support members=(diameter of roller member)−(thickness of rib members×2).

8. The belt unit according to claim 1, wherein the endless belt base material is an intermediate transfer belt which after a toner image formed on an image carrying member is primarily transferred, secondarily transfers the toner image to a recording medium.

9. The belt unit according to claim 8, wherein the intermediate transfer belt, after toner images of a plurality of colors respectively formed on a plurality of image carrying members are sequentially superimposed and primarily transferred, secondarily transfers the plurality of toner images to the recording medium in a batch.

10. The belt unit according to claim 8, wherein the roller member is arranged in the neighborhood of the secondary transfer position on an upstream side of the intermediate transfer belt in the rotation driving direction.

11. An image forming apparatus comprising:
an image carrying member;
a toner image forming member to form a toner image on the image carrying member; and
a transfer member to transfer the toner image formed on the image carrying member onto a recording medium,
wherein the transfer member includes:
an endless belt base material driven rotatably to carry a toner image;
rib members projected on both sides of an inner periphery of the endless belt base material in parallel with the rotation driving direction;
a roller member in contact with the inner peripheral surface of the endless belt base material to drive rotatably the endless belt base material; and
support members in contact with the rib members at positions opposite to the rib members on both sides of the roller member to support the rib members.

12. The image forming apparatus according to claim 11, wherein the rib members are provided on the inner periphery of the endless belt base material so that a joint has a space.

13. The image forming apparatus according to claim 12, wherein the endless belt base material is seamless.

14. The image forming apparatus according to claim 11, wherein the support members are formed in a roller shape coaxial with the roller member.

15. The image forming apparatus according to claim 14, wherein the support members rotate freely round a shaft of the roller member.

16. The image forming apparatus according to claim 11, wherein a roller diameter of the roller member is smaller than 22 mm.

17. The image forming apparatus according to claim 16, wherein the support members are formed in a roller shape coaxial with the roller member and the following formula is held:
Diameter of support members=(diameter of roller member)−(thickness of rib members×2).

18. The image forming apparatus according to claim 11, wherein the endless belt base material is an intermediate transfer belt which after a toner image formed on an image carrying member is primarily transferred, secondarily transfers the toner image to a recording medium.

19. The image forming apparatus according to claim 18, wherein a plurality of the image carrying members are provided, and the toner image forming member forms toner images of different colors respectively on the plurality of image carrying members, and the intermediate transfer belt, after the toner images of different colors on the plurality of image carrying members are sequentially superimposed and primarily transferred, secondarily transfers the plurality of toner images to the recording medium in a batch.

20. The image forming apparatus according to claim 18, wherein the roller member is arranged in the neighborhood of the secondary transfer position on an upstream side of the intermediate transfer belt in the rotation driving direction.
